(19) United States
(12) Patent Application Publication
(10) Pub. No.: US 2005/0111756 A1
(43) Pub. Date: May 26, 2005

(54) System and method for generating coherent data sets of images from various sources

(76) Inventors: Robert W. Turner, Federal Way, WA (US); Pauline Joe, Renton, WA (US); James J. Rustik, Kent, WA (US); Ingrid L. Criswell, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 10/721,212

(22) Filed: Nov. 25, 2003

(51) Int. Cl. G06K 9/32; G06K 9/00

(52) U.S. Cl. 382/294; 382/113

(57) ABSTRACT

A system, method, and user interface allowing users to easily view and compare images generated from various satellite imaging sources are provided. The system includes a user interface device, a display device, a database for storing school information, and a processor. The processor includes a first component that instructs the display device to present one of the satellite images based on the stored landmark (school) information, a second component that sets a control point in a satellite image based on a signal generated by the user interface, and a third component that aligns the images based on the set control points. The user selects a control point on a common visual feature in the image that is associated with the selected landmark.

### FIELD OF THE INVENTION

This invention relates generally to imaging and, more specifically, to using images from multiple sources.

### BACKGROUND OF THE INVENTION

Remotely-sensed imagery is a powerful utility for monitoring features and regions of the earth's surface and for detecting changes to the regions. Remotely-sensed imagery is particularly useful where there is a need, such as in agriculture, to acquire information at regular intervals and document detected changes.

However, providing customers with information products that are representative of temporally coherent data sets (e.g. satellite images) is currently problematic. For example, satellite images include multispectral radiant energy bands derived from varying sensor platforms. Although the images may cover the same geographic location at known time intervals, each sensor platform has different resolutions, sensor performance specifications, or other characteristics that make direct comparisons between each acquired image difficult. For important applications, such as command and control of situations associated with homeland security monitoring, agricultural production, natural resource management, and emergency management of natural or manmade disasters, much of the value in using satellite imagery is lost unless there are frequent and reliably correlated, near real-time data sources.

At present, dedicated systems to generate correlated images are highly inefficient. However, homeland security and emergency management demand a means to collect this information in a timely manner and correlate the images with transient information, such as forecast weather conditions. For many applications, this information is required soon after an event has occurred.

Thus, there currently exists an unmet need to generate temporally coherent data sets that are derived from multiple sources, while preserving most of the spectral information inherent in each of the sources, thereby allowing direct comparisons to be made.

### SUMMARY OF THE INVENTION

The present invention provides a system, method, and user interface allowing users to easily view and compare images generated from various satellite imaging sources. Images produced by different sensors are spatially matched and spectrally corrected. The system spatially matches the images by first aligning the images. The system includes a user interface device, a display device, a database for storing landmark information, and a processor coupled to the user interface device, the display device, and the database. The processor includes a first component that instructs the display device to present one of the satellite images based on the stored landmark information, a second component that sets a control point in a satellite image based on a signal generated by the user interface, and a third component that aligns the images based on the set control points.

In one aspect of the invention, the landmarks include schools, and the school information includes location information. The user interface device provides for selection of school information from the database and for selection of a control point on a common visual feature in the displayed satellite image that is associated with the selected school.

In another aspect of the invention, the common visual feature is a soccer field, a football field, a quarter mile track, or a baseball field.

In yet another aspect of the invention, each of the plurality of satellite images includes a plurality of multispectral bands set to the same resolution level. Each of the multispectral bands are sampled at various first resolution levels and the set resolution level is the highest of the various first resolution levels.

### BRIEF DESCRIPTION OF THE DRAWINGS

The preferred and alternative embodiments of the present invention are described in detail below with reference to the following drawings.

FIG. 1 is a block diagram of an example system formed in accordance with the present invention;

FIGS. 2-6 are flow diagrams of an example process performed by the system shown in FIG. 1; and

FIG. 7 is a screen shot of an example graphical user interface produced by the system shown in FIG. 1.

### DETAILED DESCRIPTION OF THE INVENTION

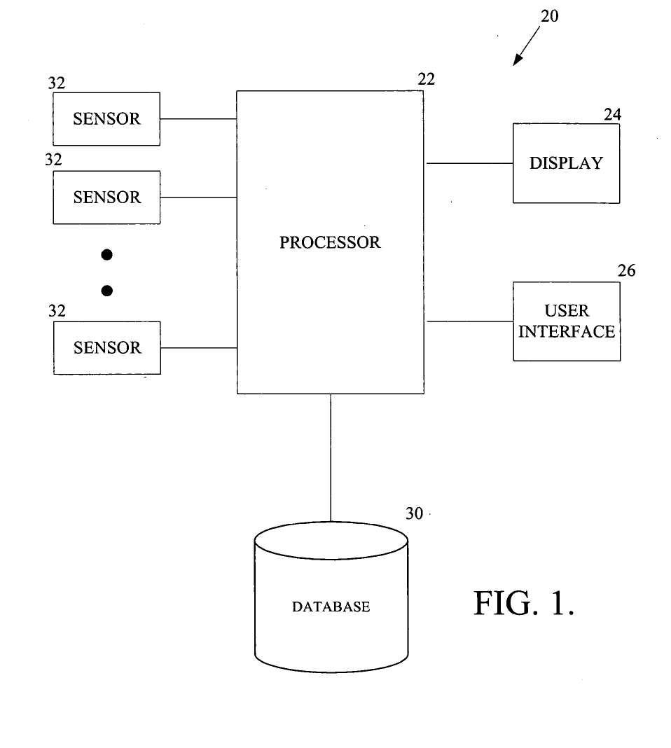

The present invention provides a system and method for geographically coordinating and radiometrically comparing and correcting a plurality of images from multiple satellite sensor sources. As shown in FIG. 1, an exemplary system 20 for performing the spatial and spectral correlation of multiple images includes a processor 22 coupled to a display 24, a user interface 26, multiple sensors 32, and a database 30. The user interface 26 includes a keyboard or cursor control device (not shown) for interacting with an application program executed by the processor 22, which is stored in the database 30 or other memory (not shown). The application program executed by the processor 22 presents a graphical user interface on the display 24. The processor 22 receives satellite images from multiple satellite sensor sources via electronic transfer or by a removable storage device. The application program allows a user to match the resolution of images of different bands of a sensor and match the resolution of images from different sensors. The application program also allows the user to radiometrically match and combine the images.

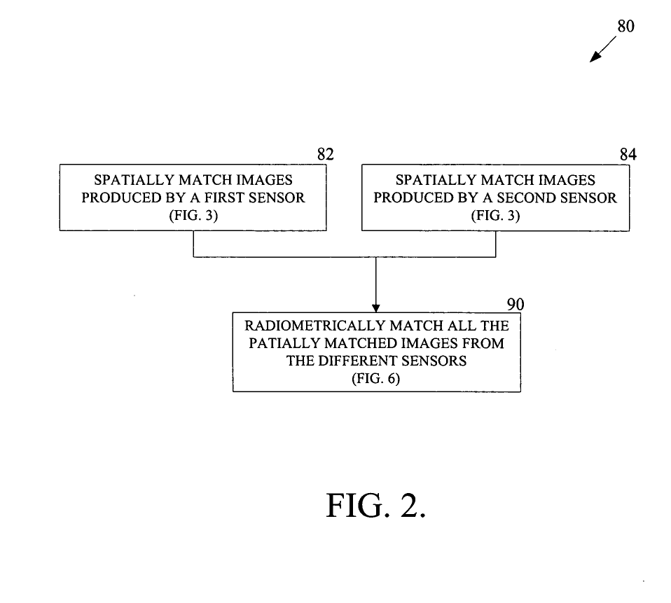

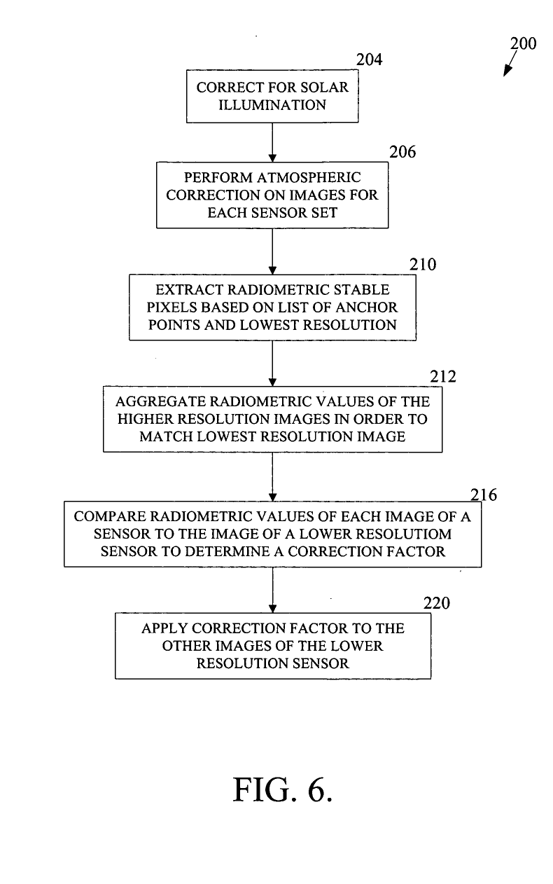

Referring now to FIG. 2, an exemplary process 80 is performed by the system 20 (FIG. 1). The process 80 begins at a block 82 at which images produced by a given sensor are spatially matched. Similarly block 84 identifies images produced by a second sensor that are also spatially matched. In one embodiment, the images are produced by satellite sensors 32 (FIG. 1) at various resolutions. Examples of this type of sensor include but are not limited to the LandSat-7 and the LandSat-5 Satellites. A sensor 32 (FIG. 1) may produce various images of multiple bands of data, such as without limitation the panchromatic band and the thermal infrared band. Each band is a collection of radiation from different ranges of the electromagnetic spectrum. At a block 90, the spatially matched images from the different sensors are radiometrically matched. Radiometric matching is described in FIG. 6 below.

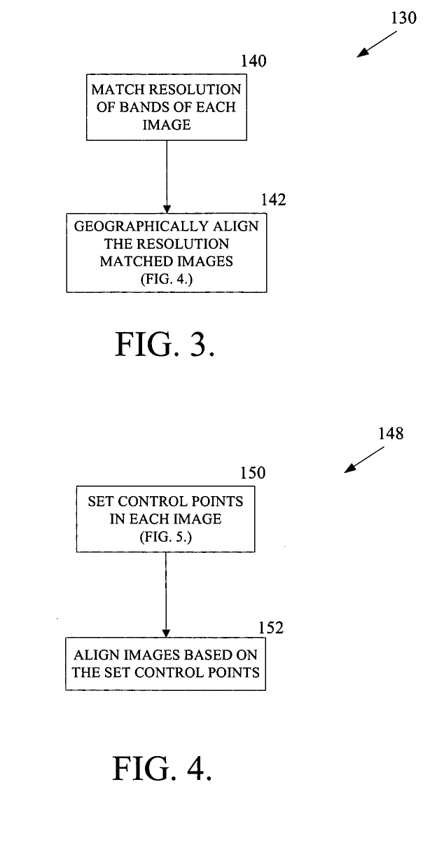

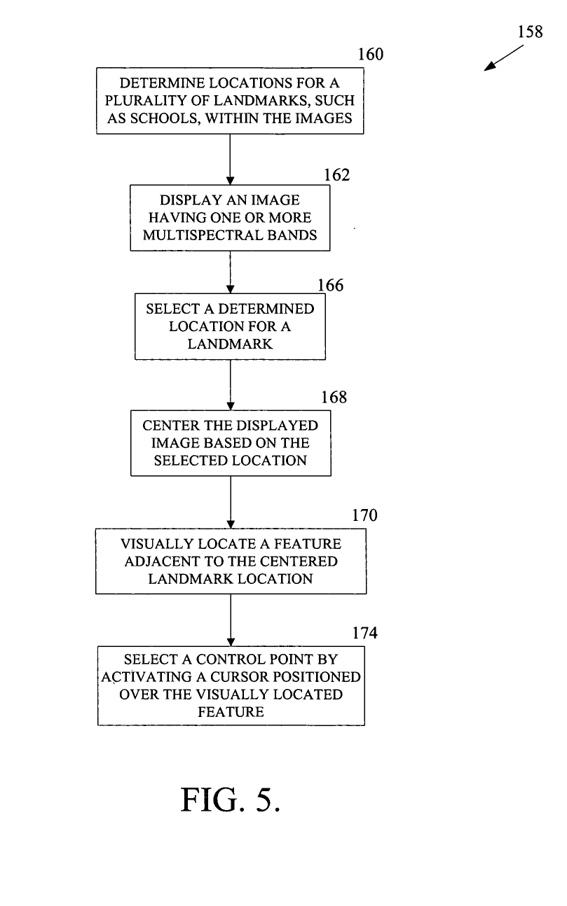

Referring to FIG. 3, an exemplary process 130 spatially matches images produced by a sensor (the block 82 of FIG. 2). Each image produced by a sensor includes multispectral bands. A band of an image is a slice of wavelength from the electromagnetic spectrum. For example, the LandSat ETM+ (Enhanced Thematic Mapper Plus) includes eight bands that collect radiation from different parts of the electromagnetic spectrum. Of the eight bands, three bands are visible light, one band is panchromatic, three bands are infrared, and one band is thermal infrared. At a block 140, the resolutions of the bands are matched to the most detailed level of all the bands of the images received from the sources. For example, if the most detailed frame unit of data in one band is 30 meters (i.e., 30 meter resolution) and 15 meter resolution is desired, the data in the 30 meter resolution frame is duplicated to occupy 4 subunits at 15 meter resolution within the original 30 meter unit. At a block 142, the resolution-matched images are geographically matched. The images are geographically oriented so that frame unit to frame unit data comparisons are geographically accurate. Geographic matching is described in more detail below in FIGS. 4 and 5.

Referring to FIG. 4, an exemplary process 148 geographically aligns images (the block 142, FIG. 3). The process 148 begins at a block 150, at which a user using the system 20 (FIG. 1) sets similar control points for each image. Setting of the control points is described in more detail below in FIG. 5 and by example in FIG. 6. At a block 152, the processor 22 aligns the images based on the set control points of the images. In one embodiment of the invention, alignment of the images is performed by comparing the location of the control points in each of the images to the control points in a first image. The other images are adjusted in order to best match the control points with the control points of the first image.

Referring to FIG. 5, an exemplary process 158 sets the control points. The process 158 begins at a block 160, at which the locations for a plurality of landmarks, such as without limitation schools, within the image are determined. It will be appreciated that any common landmark with common visual features that may appear in the images may be used as desired for a particular application. Different landmarks may be selected based upon their commonality in a particular region that is imaged. For example, schools are common landmarks in North America and typically feature common visual features, such as without limitation tracks and fields, that produce relatively consistent radiometric signatures. Other landmarks may be selected in other regions. For example, soccer stadiums are common around the world and have the same field measurements and radiation illumination.

In one exemplary embodiment, landmarks suitably are schools. For purposes of brevity and clarity, the non-limiting, exemplary embodiment in which the landmarks are schools is explained in detail below. However, it will be appreciated that descriptions of the landmarks as “schools” is given by way of non-limiting example only, and is not intended to limit interpretations or application of the present invention. The locations are latitude and longitude locations that are determined by an operator looking up latitude and longitude of suitable schools, such as high schools or colleges, located within the geographic area that are common to the images that are to be aligned. The school locations are stored in the database 30 (FIG. 1).

Referring now to FIGS. 1 and 5, at a block 162, an image is displayed on the display device 24. The displayed image suitably includes multiple visual spectrum bands (e.g., red, green, blue, near infrared) having the same resolution. Another instance of the displayed image suitable includes multiple bands of pan sharpened images as described in the co-pending and co-owned U.S. patent application Ser. No. 10/611,757, filed Jun. 30, 2003, which is hereby incorporated by reference. At a block 166, an operator using the user interface 26 selects the determined location for one of the plurality of locations, such as schools from the database 30. At a block 168, the processor 22 displays the image on the display device 24 with the selected school location at the center of the image. It will be appreciated that the image does not need to be centered about the selected school, but could be placed in a position to allow the operator to perform subsequent steps.

At a block 170, the operator visually locates a feature common to most schools and that is located adjacent to the displayed school. Features common to most schools include a soccer field, a football field, a quarter-mile track, a baseball field, or other features that present distinct visual or radiometric characteristics within a satellite image and that have standard sizes. At a block 174, the operator centers a control point cursor on the soccer field, football field, quarter-mile track, or the like, by using the user interface device 26 and activates the control point cursor to select a control point at that location. The process of setting control points is repeated for other school locations within the image, so that a certain number of control points have been selected. The processor 22 then adjusts all other images that are to be aligned with this first base image using these control points. Because quarter-mile tracks or soccer and football fields, especially fields with quarter-mile tracks surrounding them, are common features to a majority of the high schools and colleges within the United States, they provide a common control point source of a standard size that can be accurately used to align images from different sources. However, as discussed above, it will be appreciated that other common landmarks with common visual features may be selected as desired for a particular application in a particular region to be imaged.

Referring now to FIG. 6, an exemplary process 200 performs the radiometric matching that occurs at the block 90 of FIG. 2. The process 200 begins at a block 204 where all of the images are corrected for solar illumination.

From The Landsat-7 Science Data User's Handbook the following technique is used to perform the solar illumination algorithm:

Radiance to Reflectance:

For relatively clear Landsat scenes, a reduction in between-scene variability can be achieved through a normalization for solar irradiance by converting spectral radiance, as calculated above, to planetary reflectance or albedo. This combined surface and atmospheric reflectance of the Earth is computed with the following formula:

$${ρ}_{p} = \frac{π \cdot {L}_{λ} \cdot {d}^{2}}{{ESUN}_{λ} \cdot cos {θ}_{s}}$$

Where:
ρₚ=Unitless planetary reflectance
L_{λ}=Spectral radiance at the sensor's aperture
d=Earth-Sun distance in astronomical units from nautical handbook or interpolated from values listed in Table 11.4
ESUN_{λ}=Mean solar exoatmospheric irradiances from Table 11.3

θₛ=Solar zenith angle in degrees

TABLE 11.3
ETM + Solar Spectral Irradiances

| Band | watts/(meter squared * μm) |
|---|---|
| 1 | 1969.000 |
| 2 | 1840.000 |
| 3 | 1551.000 |
| 4 | 1044.000 |
| 5 | 225.700 |
| 7 | 82.07 |
| 8 | 1368.000 |

TABLE 11.4
Earth-Sun Distance in Astronomical Units

| Julian Day | Distance |
|---|---|
| 1 | .9832 |
| 15 | .9836 |
| 32 | .9853 |
| 46 | .9878 |
| 60 | .9909 |
| 74 | .9945 |
| 91 | .9993 |
| 106 | 1.0033 |
| 121 | 1.0076 |
| 135 | 1.0109 |
| 152 | 1.0140 |
| 166 | 1.0158 |
| 182 | 1.0167 |
| 196 | 1.0165 |
| 213 | 1.0149 |
| 227 | 1.0128 |
| 242 | 1.0092 |
| 258 | 1.0057 |
| 274 | 1.0011 |
| 288 | .9972 |
| 305 | .9925 |
| 319 | .9892 |
| 335 | .9860 |
| 349 | .9843 |
| 365 | .9833 |

At a block 206, atmosphere correction of each of the images is performed. Atmosphere correction is performed by first performing a cloud cover assessment such as that described in co-pending and co-owned U.S. patent application Ser. No. 10/019,459, filed Dec. 26, 2001, attorney docket no. BOEI-1-1037, which is hereby incorporated by reference. At a block 210, pixel or data values that are radiometrically stable according to the list of anchor points are selected or extracted. At a block 212, the extracted radiometric stable data values of the higher resolution images are aggregated in order to match the lowest resolution image or the image that the higher resolution image is being compared to. For example, if a LANDSAT image is at 30 meter resolution and a MODIS image is at 250 meters resolution, then all the data values in the LANDSAT image that correspond to the location of the data value from the MODIS image that corresponds to the extracted stable data value (at a control point) are combined or aggregated to form a single data value.

At a block 216, the aggregated data values of the higher resolution images are compared to the radiometric data values of the lowest resolution image. A correction factor is determined based on the comparison. At a block 220, the correction factor is applied to other images produced by the lower resolution sensor. The correction factor provides more frequent image data that is more accurate. Because certain images are produced on a less-than-frequent basis, for example LANDSAT data is produced approximately once every nine days, MODIS images that are generated every day are corrected based on the more accurate LANDSAT and other more accurate image data. The correction factor is applied to all the MODIS images that are generated until the next time in which a LANDSAT image is produced and the process 200 is repeated.

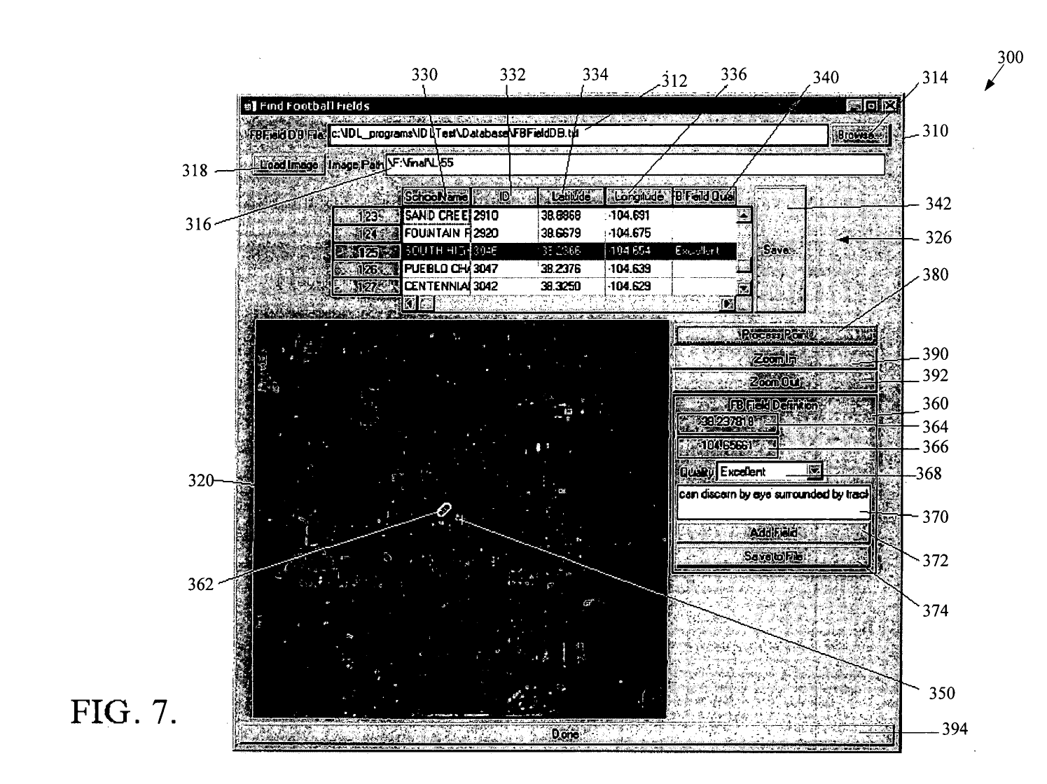

FIG. 7 illustrates a non-limiting example screen shot of a graphical user interface 300 presented on the display device 24 by the processor 22 using information stored in the database 30 and an image previously received by one of the sensors. The graphical user interface 300 is suitably a window 310 run in a windows-based operating system. The window 310 includes a database locator field 312 that includes a browse button 314 for allowing an operator to save his/her control points to a specified database. The window 310 also includes an image location identifier field 316 that indicates the stored location of a satellite image. A load image button 318 is located adjacent to the field 316 and when activated loads the image associated with the address presented in the field 316 into an image display area 320. Located below the field 316 is a scrollable school location table 326 that presents school location information stored in the database 30. The school location table 326 includes rows of schools each being identified by a reference number. Each row includes a school name column 330, an identification (ID) column 332, a latitude column 334, a longitude column 336, and a field quality column 340. The school name column 330 includes a full or abbreviated school name in the row. The ID column 332 identifies an ID number for the named school. The latitude and longitude columns 334 and 336 include latitude and longitude information of the associated school. The school location table 326 also includes a save button 342, which saves the list of schools that fall within the image. The operator selects a school from the school table 326 by highlighting the desired school in the table 326. The operator highlights the desired school by using the cursor control device, such as a mouse, a keyboard or by using a touch-screen display. When a school is processed from the school table 326 by activating a process point 380, the image displayed within the image display area 320 is positioned so that the location of the selected school is centered under a center crosshair 350 of the image display area 320.

A control point cursor 362 is suitably a crosshair cursor located within the image display area 320. The control point cursor 362 is manipulated by a cursor control device, such as those described above. The operator controls the control point cursor 362 to place it over an oval shape near the school that is located under the center crosshair 350. The oval shape is most likely a quarter mile track. Adjacent to the image display area 320 is a control point definition area 360. Within the control point definition area 360 are latitude and longitude position indicators 364 and 366 that provide the latitude and longitude information for the control point cursor 362 presently located within the displayed image area 320. Located below the longitude position indicator 366 is a quality level selector field 368 that is suitably in the form of a pull-down menu. The operator selects from preset quality values in the quality level selector field 368 that the operator determines as being the visual quality of the displayed field. The quality value selected in the quality level selector field 368 is placed into the field quality column 340 for the selected school. Below the quality level selector field 368 is a comments window 370 that allows the operator to enter comments regarding anything of concern regarding the selected control point. An add field button 372 is located below the comments area 370. When activated the add field button 372 identifies the geographic location shown in the indicators 364 and 366, (i.e., the location of the control point cursor 362) as a control point. A save button 374 when activated saves all identified control points (i.e. added fields). Also adjacent to the image display area 320 are zoom in and zoom out buttons 390 and 392 that when selected zooms the displayed image in/out, respectively. The done button 394 when selected exits out of the process.

While the preferred embodiment of the invention has been illustrated and described, as noted above, many changes can be made without departing from the spirit and scope of the invention. For example, it is appreciated that the process steps in the flow diagrams can be performed in various order without departing from the spirit and scope of the invention. Accordingly, the scope of the invention is not limited by the disclosure of the preferred embodiment. Instead, the invention should be determined entirely by reference to the claims that follow.

1. A method for correlating data from images produced by different sensors, the method comprising:
spatially matching images produced by different sensors; and
spectrally correcting one or more of the spatially matched images based on one or more of the other images.

2. The method of claim 1, wherein spatially matching includes equalizing resolution levels in the images.

3. The method of claim 2 wherein spatially matching further includes:
setting a plurality of control points in the images based on landmark information; and
aligning the images based on the set control points.

4. The method of claim 3, wherein setting the plurality of control points includes:
a. determining locations of a plurality of landmarks within a geographic area associated with the images;
b. displaying one of the images;
c. adjusting the displayed image to present a selected landmark;
d. setting a control point associated with a visual feature that is approximately adjacent to the selected location of the landmark; and
e. repeating c-d until a threshold number of control points have been set; and

5. The method of claim 3, wherein the landmark information includes schools.

6. The method of claim 5, wherein the visual feature is one of a soccer field, a football field, a quarter mile track, or a baseball field.

7. The method of claim 3, wherein each of the plurality of images includes a plurality of multispectral bands set to equalized resolution levels.

8. The method of claim 7, wherein each of the multispectral bands are sampled at various first resolution levels and the set resolution level is the highest of the various first resolution levels.

9. A system for correlating data from two or more satellite images from different sensors, the system comprising:
means for spatially matching images produced by different sensors; and
means for spectrally correcting one or more of the spatially matched images based on one or more of the other images.

10. The system of claim 9, wherein the means for spatially matching includes means for equalizing resolution levels in the images.

11. The system of claim 10, wherein the means for spatially matching further includes:
means for setting a plurality of control points in the satellite images based on landmark information;
means for aligning the images based on the set control points; and
means for aligning the images based on the center latitude and center longitude of the base image.

12. The system of claim 11, wherein the means for setting includes:
means for determining locations of a plurality of landmark within a geographic area common with the satellite images;
means for displaying one of the satellite images;
means for selecting one of the plurality of landmarks;
means for adjusting the displayed satellite image to present the selected landmark based on the determined location; and
means for selecting a control point associated with a visual feature that is approximately adjacent to the selected landmark.

13. The system of claim 12, wherein the landmark includes schools.

14. The system of claim 12, wherein the visual feature is one of a soccer field, a football field, a quarter mile track, or a baseball field.

15. The system of claim 12, wherein each of the plurality of satellite images includes a plurality of multispectral bands set to equalized resolution levels.

16. The system of claim 15, wherein each of the multispectral bands are sampled at a plurality of first resolution levels and the set resolution level is the highest of the plurality of first resolution levels.

17. A system for aligning a plurality of satellite images from different sources, the system comprising:
a user interface device;
a display device;
a database for storing landmark information; and
a processor coupled to the user interface device, the display device, and the database, the processor including:
a first component for instructing the display device to present one of the satellite images based on the stored landmark information;
a second component for setting control points in the satellite images based on a signal generated by the user interface; and
a third component for aligning the images based on the set control points.

18. The system of claim 17, wherein the landmark includes school information.

19. The system of claim 18, wherein school information includes location information.

20. The system of claim 17, wherein the user interface includes a first component for selecting landmark information from the database.

21. The system of claim 17, wherein the user interface includes a second component for selecting a control point on a visual feature in the displayed satellite image that is associated with the selected landmark.

22. The system of claim 21, wherein the visual feature is one of a soccer field, a football field, a quarter mile track, or a baseball field.

23. The system of claim 17, wherein each the plurality of satellite images includes a plurality of multispectral bands set to equalized resolution levels.

24. The system of claim 23, wherein each of the multispectral bands are sampled at various first resolution levels and the set resolution level is the highest of the various first resolution levels.

25. A user interface for selecting control points on a plurality of satellite images from different sources for alignment, the user interface comprising:
a first component for displaying one of the satellite images;
a second component for selecting a landmark from a database of landmarks located within a geographic area common to the plurality of satellite images;
a third component for adjusting the displayed satellite image to present the selected landmark; and
a fourth component for selecting a control point associated with a visual feature that is approximately adjacent to the selected landmark.

26. The user interface of claim 25, wherein the landmark includes schools.

27. The user interface of claim 25, wherein the visual feature is one of a soccer field, a football field, a quarter mile track, or a baseball field.

28. The user interface of claim 25, wherein each the plurality of satellite images includes a plurality of multispectral bands set to equalized resolution levels.

29. The user interface of claim 28, wherein each of the multispectral bands are sampled at a plurality of first resolution levels and the set resolution level is the highest of the plurality of first resolution levels.

30. A method for correlating data from images produced by different sensors, the method comprising:
spatially matching images produced by different sensors;
setting a plurality of control points in the images based on landmark information; and
spectrally correcting one or more of the spatially matched images based spectral information associated with one or more of the set control points in the images.

31. The method of claim 30, wherein spectrally correcting includes:
extracting radiometrically stable data associated with the set control points;
aggregating the extracted radiometrically stable data from a first image from a first sensor having a resolution that is higher than a second image from a second sensor;
comparing the aggregated data of the first image to the extracted radiometric data of the second image;
generating a correction factor based on the comparison; and
applying the correction factor to all the radiometric data of the second image.
